(19) United States
(12) Patent Application Publication
(10) Pub. No.: US 2015/0006401 A1
(43) Pub. Date: Jan. 1, 2015

(54) Clip Rate Adjustment

(71) Applicant: Cisco Technology Inc., San Jose, CA (US)

(72) Inventors: Adi Alter, Jerusalem (IL); Shimon Ovadia, Jerusalem (IL); Avraham Poupko, Jerusalem (IL)

(21) Appl. No.: 14/369,383

(22) PCT Filed: Jan. 9, 2013
(86) PCT No.: PCT/IB2013/050172

§ 371 Date: Jun. 27, 2014

Related U.S. Application Data
(60) Provisional application No. 61/631,693, filed on Jan. 9, 2012.

(51) Int. Cl. G06Q 30/02; H04L 29/06

(52) U.S. Cl. CPC G06Q 30/0277; H04L 63/123; G06Q 2220/10
USPC 705/51

(57) ABSTRACT

A system and method for coupon distribution is described, the system and method including an electronic publisher implemented on one of a computer or processing device operative to publish an electronic publication including at least one offer to receive a discount on the purchase of a product, an encryption engine which encrypts each copy of the electronic publication to a key specific to one device among a plurality of devices including a known number of individual devices, distribution apparatus implemented on one of a computer or processing device which distributes, at least at a first time, the encrypted electronic publication to each individual device among the plurality of devices, confirmation receiving apparatus implemented on one of a computer or processing device which receives confirmation from the individual devices that the at least one offer has been accepted on the one device, and one of a computer or processing device including a counter which counts the number of confirmations received, a calculator which calculates a clip rate based on dividing the number of confirmations received by the known number of individual devices, and a processor which, based on a result of the calculation of the clip rate, adjusts the number of individual devices including a second plurality of devices, to which, at a second time, the electronic publication is to be distributed by the distribution apparatus. Related methods, systems and apparatus are also described.

### RELATED APPLICATION INFORMATION

The present application claims the benefit of priority from U.S. provisional patent application Ser. No. 61/631,693, filed 9 Jan. 2012. The disclosure of U.S. provisional patent application Ser. No. 61/631,693 is incorporated herein by reference.

### FIELD OF THE INVENTION

The present invention relates to a method and system for distributing redeemable tokens, and more specifically, to a method and system for distributing redeemable tokens to devices which are not always on-line.

### BACKGROUND OF THE INVENTION

The following references are believed to reflect the state of the art:

Opportunities of Interactive Formats for Innovative Advertising on Digital Television, Katrien Berte, Patrick Vyncke, and Els De Bens, EnrolTV 2010, Jun. 9-11, 2010; and

MobiAd: Private and Scalable Mobile Advertising, Hamed Haddadi, Pan Hui, and Ian Brown, Mobi Arch '10, Sep. 24, 2010.

The following patent literature references are also believed to reflect the state of the art:

U.S. Pat. No. 5,508,731 of Kohorn;

U.S. Pat. No. 6,057,872 to Candelore;

U.S. Pat. No. 6,681,393 to Bauminger et al.;

US 2002/0157111 of Reams;

US 2005/0060232 of Maggio; and

US 2008/0022302 of Tanaka et al.

### SUMMARY OF THE INVENTION

The present invention, in certain embodiments thereof, seeks to provide an improved method and system for distribution of redeemable tokens.

There is thus provided in accordance with an embodiment of the present invention a system including an electronic publisher implemented on one of a computer or processing device operative to publish an electronic publication including at least one offer to receive a discount on the purchase of a product, an encryption engine which encrypts each copy of the electronic publication to a key specific to one device among a plurality of devices including a known number of individual devices, distribution apparatus implemented on one of a computer or processing device which distributes, at least at a first time, the encrypted electronic publication to each individual device among the plurality of devices, confirmation receiving apparatus implemented on one of a computer or processing device which receives confirmation from the individual devices that the at least one offer has been accepted on the one device, and one of a computer or processing device including a counter which counts the number of confirmations received, a calculator which calculates a clip rate based on dividing the number of confirmations received by the known number of individual devices, and a processor which, based on a result of the calculation of the clip rate, adjusts the number of individual devices including a second plurality of devices, to which, at a second time, the electronic publication is to be distributed by the distribution apparatus.

Further in accordance with an embodiment of the present invention the confirmation received from one device among a plurality of devices is encrypted to the key specific to the one device.

Still further in accordance with an embodiment of the present invention the coupon is redeemable once it is clipped on the one device.

Additionally in accordance with an embodiment of the present invention a coupon is redeemable within a window of opportunity.

Moreover in accordance with an embodiment of the present invention the one device is only occasionally connected to a network.

Further in accordance with an embodiment of the present invention the network includes the Internet.

Still further in accordance with an embodiment of the present invention the system further monitors coupon redemption rate.

Additionally in accordance with an embodiment of the present invention the processor, based on the coupon redemption rate further adjusts the number of individual devices including a second plurality of devices, to which, at a second time, the electronic publication is to be distributed by the distribution apparatus

Moreover in accordance with an embodiment of the present invention and further including an upper threshold, denoted N, N being a maximum number of redeemable tokens available for distribution by the distribution apparatus, and the confirmation from received the one device including, at least a time-stamp, and device identification information.

Further in accordance with an embodiment of the present invention the time-stamp includes a time stamp from a secure clock.

Still further in accordance with an embodiment of the present invention the secure clock is included in a secure hardware element included in the device.

There is also provided in accordance with another embodiment of the present invention a method including distributing, at a first time, an electronic publication including at least one offer to receive a discount on the purchase of a product to a plurality of devices including a known number of devices, wherein each of the electronic publications which is distributed to one device of the plurality of devices is encrypted to a key specific to the one device, receiving confirmation from devices including a subset of the plurality of devices that have been accepted the at least one offer, counting the number of confirmations received, calculating a clip rate based on dividing the number of confirmations received by the known number of devices, and distributing the electronic publication, at least at a second time, to an adjusted number of the devices, wherein the adjusted number is adjusted according to at least a result of the calculating the clip rate.

### BRIEF DESCRIPTION OF THE DRAWINGS

The present invention will be understood and appreciated more fully from the following detailed description, taken in conjunction with the drawings in which:

FIG. 1 is a sequence diagram of a first embodiment of a system for distributing redeemable tokens constructed and operative in accordance with an embodiment of the present invention;

FIG. 2 is a sequence diagram of an enhanced version of the embodiment of the system for distributing redeemable tokens of FIG. 1;

FIG. 3 is a block diagram of apparatus implemented in a coupon distributing headend comprising the server of FIGS. 1 and 2; and

FIG. 4 is a flowchart diagram depicting a method for an embodiment of the systems of FIGS. 1-3.

### DETAILED DESCRIPTION OF AN EMBODIMENT

Reference is now made to FIG. 1, which is a sequence diagram of a system for distributing redeemable tokens constructed and operative in accordance with an embodiment of the present invention.

Tokens of some sort are often used as an indicator that a party is entitled to exchange or redeem the token for a particular benefit. In the digital era, the use of digital tokens loaded on a device (specifically a computing device or a processing device) is becoming more prevalent. Digital tokens may be used by the holder of a device a number indicating a place in a line (such as, but not limited to a line to receive a service). Tokens may indicate a reservation, for instance, a holder of a token may have reserved the right to use a express lane of a highway. Without the token, a person may have to pay more for that right, or be potentially subjected to a fine. A token may also be a discount coupon, entitling a holder of the token to pay a lower price for a good or a service (for example, and without limiting the generality of the foregoing, a certain amount may be deducted from the price of an article when redeeming the token, or the redemption of the token may entitle the redeemer to purchase three articles for the price of two.)

With the advent of the Internet and hand held devices, such as tablet computers and smart phones, the availability of digital redeemable tokens presents additional challenges and opportunities for distributing coupons. If the tokens are distributed as digital media, then, even allowing that the tokens are digitally signed and otherwise protected against copying by some sort of DRM or other copy-protection mechanism, thereby preventing near-infinite copying of the tokens. There is a need for preventing a user from taking an action to download the token repeatedly (for instance, clicking a “CLICK COUPON” button repeatedly). For example, coupons can be sent by a coupon distribution center encrypted to a device specific encryption key, and a confirmation that an individual device has accepted (i.e. “clipped the coupon”) an offer of a coupon is sent back to the coupon distribution center encrypted.

Digital distribution of such redeemable tokens allows for tighter control of the tokens, where the provider of the tokens wishes to exert a limit on the number of available tokens. On the one hand, the provider of the tokens does not want the total amount of distributed tokens to exceed the budget. On the other hand, without unnecessary limits the provider wants to ensure that opportunities to obtain the tokens are not limited needlessly.

By way of example, if the tokens represent a place in a line to receive a service, on the one hand, the provider of the tokens does not wish to create a surfeit of tokens, which may result in more holders of the tokens than can be reasonably serviced in a given amount of time, and on the other hand, if too few of such tokens are available, some end users may be tempted to horde tokens, and sell them to other potential end users, who might be willing to pay a premium to improve their place in line.

In the print world, in the realm of printed coupons, the provider of coupons for use by a consumer typically has a budget constraint. Only a certain amount of money, say $B, has been allocated for use in the coupon campaign for a particular product. If each coupon provides the user of that coupon a fixed amount, $F, as a discount for purchasing the product, then, in principle, the provider of coupons only want to make $B/$F=X coupons available in the campaign. For instance, if a total of $B=$100,000 were to be allotted as potential discounts to be given by the provider of coupons, and each coupon gives $F=$1 off the price of the product, then, X=100,000 total coupons to be redeemed.

Typically, when coupons were distributed as printed coupons (by way of a non-limiting example, coupons which are clipped from a newspaper or a magazine), ideally, the provider of the coupons would only distribute X coupons. In practice this was not done, since not all of the X distributed coupons would be clipped and used by consumers purchasing the product. Rather, some amount of coupons Y (where Y≧X), were typically printed. Y is based on estimates of the redemption rate. The fact that Y is based on estimates makes it difficult for the provider of coupons to budget the advertising campaign which included the providing of the coupons.

In some cases, one of the following may occur with printed coupons:
Either too many coupons have been redeemed and the issuer of the coupon is forced to honor more coupons than he had budgeted for; or
too few coupons have been available for clipping and subsequent redemption (due to the fact that there were not enough coupons distributed)—resulting in a missed opportunity.

If the coupons are distributed as digital media, then, even allowing that the coupons are digitally signed and otherwise protected against copying by some sort of DRM or other copy-protection mechanism, thereby preventing near-infinite copying of the coupons, there is a need for preventing a user from clicking a “CLICK COUPON” button repeatedly. Furthermore, even if each clipper of a virtual coupon were somehow limited to clipping only one of the virtual coupons (and no scripts were to be run to automatically clip large numbers of coupons), X may quickly be exceeded.

Due to the virtual nature of digital coupons, clipping becomes a more significant matter. Clipping is the act of associating a digital coupon with a specific user (i.e. the clipper) in a manner that, at least in potential, the coupon can later be redeemed. A consequence of clipping the coupon is that, when the amount of coupons is regulated, then if one coupon is clipped, one fewer coupon is available to be clipped. However, because not all clipped coupons are indeed redeemed, there might be more coupons made available for clipping than are available for redemption.

It is worth noting that once a coupon has been ‘clipped’ and the clipped coupon is within a window of usage (i.e. within a time period prior to the expiration date of the coupon) the issuer of the coupon will allow it to be redeemed.

Digital coupon distribution allows for tighter control of the budget of the coupon campaign, ensuring that one the one hand the amount of coupons redeemed does not exceed the budget, and on the other, unnecessary limits on the opportunities to clip coupons are not imposed. In general, in the print world, if X coupons are printed, then only Y coupons can be clipped, where Y≦X. And furthermore, only Z coupons can be redeemed, where Z≦Y. However, in the digital world, without some regulation on the clipping rate and the redemption rate, Y can easily exceed X, and Z can easily exceed Y, due to the known problem of the nature of perfect digital copying.

Embodiments of the present invention are implemented typically in handheld devices that are either: occasionally on-line and occasionally off-line (on/off-line meaning connected to the Internet); or alternatively, always on-line. If the device is always on-line, the moment the last token is redeemed, then all tokens still unredeemed (i.e., in the realm of coupons, clipped but not yet used), may now become unavailable for redemption.

The system of FIG. 1 comprises a server 110, a user device 120, and a redemption center 130. As noted above, the user device 120 is typically occasionally on-line and occasionally off-line, such as a smart phone or tablet computing device which may not always be in a location where it is able to access the Internet. Additionally, a redemption center 130 is available, such that the user of the user device 120 is able to redeem the redeemable token at the redemption center 130 in exchange for the good(s) service(s) for which the token may be redeemed.

It is appreciated that typically a user (or a family of a user) is associated with the user device 120. This association is considered to be so strong that the user and the user device 120, may, for many applications described herein, be considered interchangeable. For example, a request sent from the user device 120 to the server 110 to receive a token for later use, may be understood to be essentially the same as a request by the user of the user device 120 (i.e. the user associated with the user device 120) to receive the token from the server 110 for later use.

The server 110 may receive a number N 140 which is indicative of the upper limit of tokens to be distributed within a window of usage (i.e. within a time period prior to the expiration date of the tokens). For instance, and without limiting the generality of the foregoing, if the tokens indicate that the holder of the token may have reserved the right to use a express lane of a highway, then the window of opportunity may be for a 24 hour period. On the other hand, if the tokens are used as numbers indicating a place in a line, then the token may have a window of opportunity of, at most, a few hours. Alternatively, if the tokens are redeemable as digital coupons, then the window of opportunity may be a month of longer.

At some point within the window of opportunity, the user of user device 120 inputs to the interface of user device 120 a request for a redeemable token from the provider of the tokens. The user device 120 prepares a message 150 comprising at least a time stamp, indicative of the time the message was prepared; device identification information; and a request for a redeemable token 160. In some embodiments of the present invention, the time stamp may be optional. Additionally, in some embodiments of the present invention, the token does not have to come back to the user device. It may be that the token is added to the user's account on the server 110, and is redeemed later, without the device 120 being involved in the redemption.

The user device 120 then sends the message 150 comprising the request for the token 160 to the server 110, at the next opportunity when the user device 120 is on-line.

The server 110, in response to receiving the message 150 comprising the request for the token 160 responds by sending or delivering the requested token 160 to the user device 120. Once the user device 120 receives the token 160, the user of the user device 120 may then redeem the redeemable token 160 at the redemption center 130.

In cases where more requests for redeemable tokens 160 are received at the server 110 than there are redeemable tokens 160 available for distribution, the server 110 is able to compare the time stamps in all of the received messages 150, and only send out the first up to N tokens (i.e. the upper limit of tokens 160 to be distributed within a window of usage) to the first N-earliest requests for a token.

This might occur in any of these exemplary cases: there might be only a limited number of numbers of places in line which may be reserved in the fashion described herein, on a given day; only a set number of drivers may opt to obtain the right to use a express lane on a highway; or, there might be a limited number of coupons available for a given campaign.

It is appreciated that as an additional way of securing the messages 150, the time stamp may, in some embodiments, comprise a time stamp from a secure clock. The secure clock, in such a case, may be comprised in a secure hardware element comprised in the user device 120. Still further, the secure hardware element may comprise a removable secure hardware element. While it is preferable for the clock which provides the time stamp to be a secure clock, the nature of the device might preclude this. In such a case, a non-secure clock comprised in the device will, per-force, provide the time stamp.

In certain embodiments of the present invention, only a registered user may be eligible to receive a token 160. A registered user may have a user identification number or user name, and the user may be required to provide that information to the server 110 to receive a token. Alternatively, there may not be a formal registration process; however, the user of the user device 120 may be required to provide some identification information (e.g. a phone number, an email address, a credit card number, and so forth) to the server 110 in order to receive the token 160.

By way of example, if the user is using the user device 120 to receive a number reserving a place in line, then the user device 120 may be required to provide an email address or a phone number to the server 110, so that the user device may be contacted when it is estimated that the token's 160 turn is going to occur within the next 15 minutes.

In the case where the token represents the right to use an express lane on a highway, then the user device 120 may be required to provide the server 110 a credit card number, so that the user may be billed the premium price for use of the express lane.

In cases where the token is used as a coupon, the coupon may only be distributed to a user who is a holder of a loyalty card of a certain store or chain.

The server 110 may send the redemption center 130 (or other business unit related to distribution of the redeemable tokens 160) a digest 170 of transactions which are executed by the server 110.

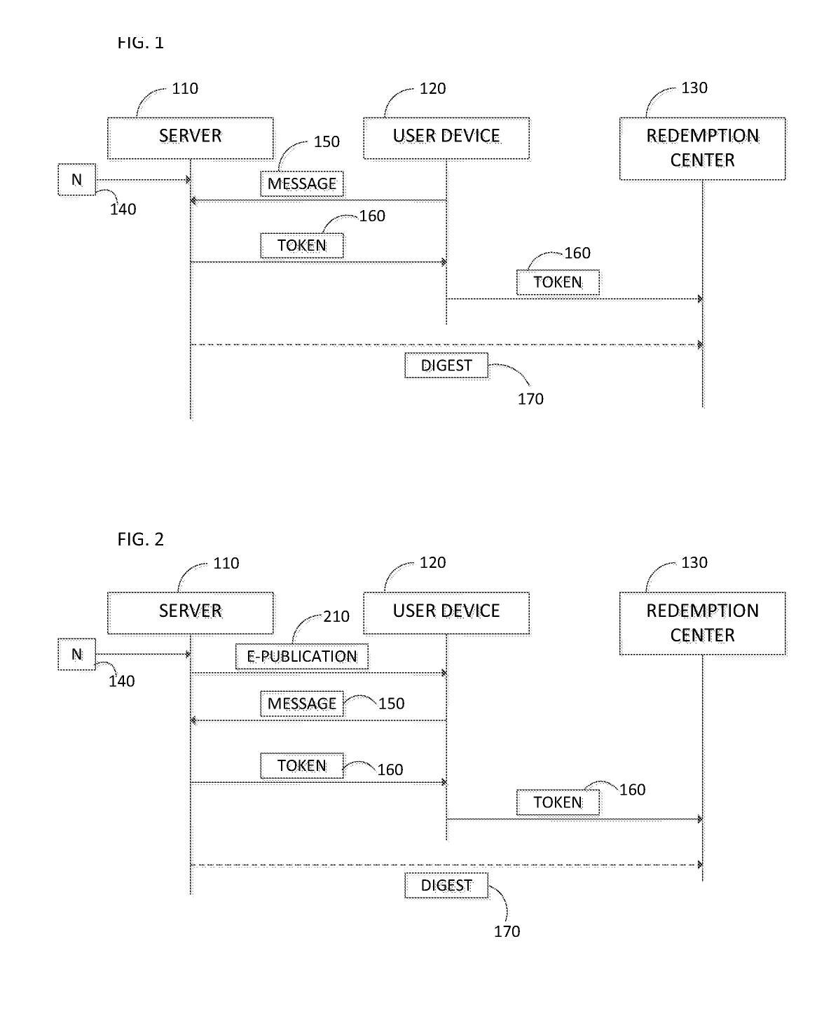

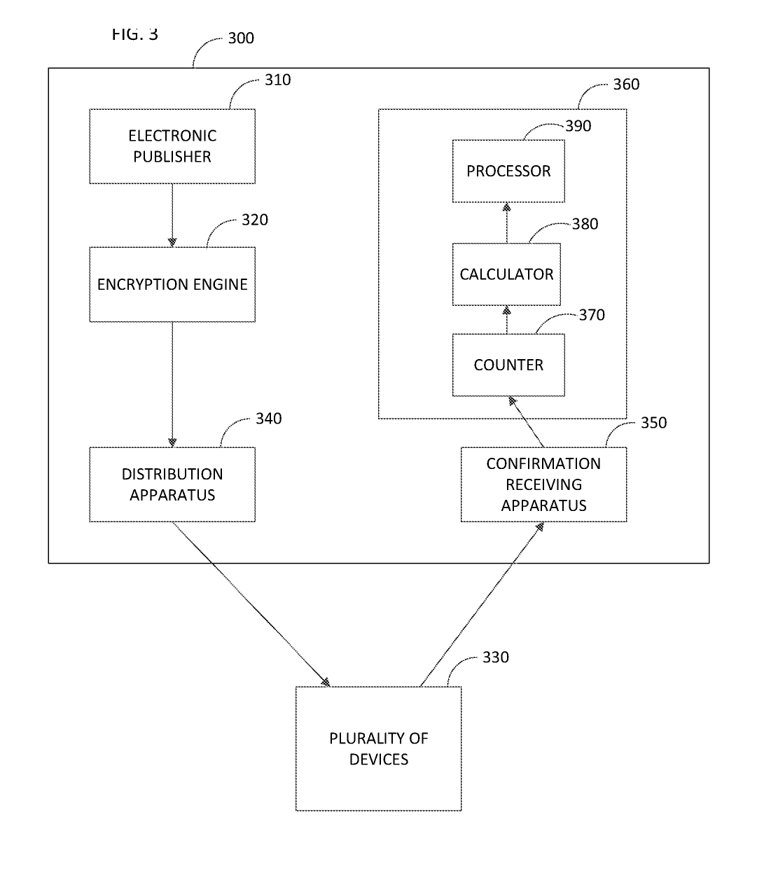

Reference is now made to FIG. 2, which is a sequence diagram of an enhanced version of the embodiment of the system for distributing redeemable tokens of FIG. 1. FIG. 2 is essentially the same as FIG. 1, as described above, with the enhancement described below.

Reference is now additionally made to FIG. 3, which is a block diagram of apparatus 300 implemented in a coupon distributing headend comprising the server 110 of FIGS. 1 and 2. It is appreciated that the server 110, per se, is not depicted in FIG. 3. Rather, for ease of depiction at least one of the components of FIG. 3 (individually or in combination) may be the “server 110” of FIGS. 1 and 2. For instance, and without limiting the generality of the foregoing, distribution apparatus 340 and/or confirmation receiving apparatus 350 of FIG. 3 may be implementations of the server 110 of FIGS. 1 and 2. Furthermore, components in FIG. 3 which are indicated as being implemented on one of a computer or processing device may all be implemented on individual computers or processing devices; may all be implemented on the same computer or processing device; or some combination of the components may be implemented on the same computer or processing device while others may be implemented either individually or implemented in combination with still other components.

An electronic publication 210 is made available to the user device 120. The electronic publication 210 comprises at least one offer for a redeemable token 160 from a provider of redeemable tokens 160. For example the redeemable token 160 may be a coupon, and the electronic publication 210 may be an electronic magazine offering at least one discount coupon. The electronic publication 210 is published by an electronic publisher 310. The electronic publisher 310 is implemented on one of a computer or processing device.

Each copy of the electronic publication 210 is encrypted by an encryption engine 320 to an encryption key specific to one device among a plurality of devices 330 which are to receive the electronic publication 210. In the digital milieu, the electronic publication 210 is at risk of being further distributed to other devices from the receiving device. Accordingly, encrypting the copy of the electronic publication 210 ensures that the electronic publication 210 may only be decrypted by the holder of the decryption key. To further ensure that only the receiver of the key is using the coupons and not someone else replies to the coupon distributing headend may also be encrypted using the same key. Ensuring that only the proper recipient of the electronic publication 210 is able to receive the coupons helps ensure that the number of devices which receive the electronic publication 210 is known to the coupon distributing headend 110 (thereby enabling calculation of the clip rate of the coupon).

The encrypted electronic publication 210 is distributed by a distribution apparatus 340 which is implemented on one of a computer or processing device. The distribution apparatus 340 distributes, over a communication network (such as, but not limited to a LAN, a WAN, an Intranet, and the Internet), the encrypted electronic publication 210 to each individual device among the plurality of devices 330.

Once a coupon is clipped (as explained elsewhere herein), a confirmation is sent from the individual device on which the clipping occurs is sent to a confirmation receiving apparatus 350 at the coupon distributing headend. It is also appreciated that each device of the plurality of devices 330 is capable of being on-line part of the time and off-line the remainder of the time. (“Being off-line” is understood to mean that the device is not switched off, and is not connected to the Internet.) Therefore, the individual device will only send the confirmation when an opportunity to do so presents itself.

The confirmation receiving apparatus 350 is implemented on one of a computer or processing device and receives confirmation from the individual devices that the at least one offer has been accepted on that individual device. As was noted above, the confirmation may be returned to the coupon distributing headend encrypted to the same encryption key as was used for encrypting the electronic publication 210.

It is appreciated that once the coupon is clipped on an individual device the coupon is redeemable.

The coupon distribution headend comprises at least one of a computer or processing device 360 comprising:
a counter 370 which counts the number of confirmations received;
a calculator 380 which calculates a clip rate based on dividing the number of confirmations received by the known number of individual devices; and
a processor 390 which, based on a result of the calculation of the clip rate, adjusts the number of individual devices comprising a second plurality of devices, to which, at a second time, the electronic publication is to be distributed by the distribution apparatus.

Returning now to the discussion of FIGS. 1 and 2, and in view of the above discussion of FIG. 3, the electronic publication 210 comprises at least one offer for a redeemable token 160 from a provider of redeemable tokens 160. For example, and without limiting the generality of the foregoing, the electronic publication 210 may comprise an offer such as a message which is broadcast to user devices 120 which enter a government office building (assuming that there is some appropriate application on the user device 120 operative to receive the message), the offer may then appear on the screen of the user device 120 (with appropriate sound and vibratory queuing to notify the user associated with the user device 120 of receipt of the offer). The offer may prompt the user to press a button on a touch screen of the user device 120. Pressing the button on the touch screen of the user device 120 results in the user device 120 receiving a token which indicates the user's place in line to receive service at the government office.

Alternatively, the electronic publication 210 may be an electronic magazine which offers a number of discount coupons to the user of the user device 120. In either of these cases, or in a similar case, the message 150 sent by the user device 120 to the server 110 comprises a request for the redeemable token 160 (or at least one of the redeemable tokens 160) offered in the electronic publication 210.

It is appreciated that although the server 110 which distributes the electronic publication 210 is described herein as the same server 110 which receives the message 150 and distributes the token 160, the server 110 which distributes the electronic publication 210 may, in fact comprise a different server than the server 110 which receives the message 150 and distributes the token 160. For ease of description, however, a single server 110 is discussed.

In embodiments where the user device receives the electronic publication 210 comprising at least one offer for a redeemable token 160 from a provider of redeemable tokens 160, then the electronic publication 210 may be selectively distributed by the server 110. For example, only residents of a certain geographic area may receive the electronic publication 210. Alternatively, only a certain demographic group (e.g. women over the age of 35 who reside within a 50 mile radius of Chicago, Ill.) may receive the electronic publication 210. In some embodiments, only registered users who have not purchased a certain product may receive the electronic publication 210.

In some embodiments, only a limited number of electronic publications 210 may be distributed to user devices 120. For instance, if only one hundred and fifty people will be served in a given government office on a given day, then only one hundred and fifty electronic publications 210 offering a token indicative of a place on line will be distributed.

However, if, after one hundred and fifty electronic publications 210 are distributed in the above example and only seventy five tokens 160 are given out by 10:00 AM, then an additional seventy five electronic publications 210 are distributed at 10:00 AM.

The preceding example in the realm of discount coupons requires a brief introduction. It was already noted above that the provider of coupons for use by a consumer typically has a budget constraint. Only a certain amount of money, say $B, has been allocated for use in the coupon campaign for a particular product. If each coupon provides the user of that coupon a fixed amount, $F, as a discount for purchasing the product, then, in principle, the provider of coupons only want to make $B/$F=N coupons available in the campaign. For instance, if a total of $B=$100,000 were to be allotted as potential discounts to be given by the provider of coupons, and each coupon gives $F=$1 off the price of the product, then, N=100,000 total coupons to be redeemed.

N can be changed/varied, at least in part depending on the number of messages 150 comprising requests for the token 160 received at the server. For instance, if a particular coupon campaign is very popular, N can be increased. Alternatively, N can be decreased in such a case, to decrease the scope and cost of the campaign.

In a first embodiment, N can be modified according to the following scheme: Only X (i.e. N=X) coupons are provided by the provider of coupons. The X coupons are available at a coupon distributing headend. During a first opportunity during which coupons may be clicked, some amount of coupons, Y, are clipped. Thus, during a second opportunity during which coupons may be clicked only X−Y (now N=X−Y) virtual coupons remain available. The amount of coupons made available during the second opportunity is, accordingly, adjusted so that it does not exceed X−Y (i.e. N) coupons.

The decision regarding which users are first offered the chance to clip the coupons from the electronic publication 210 can be based on different criteria such as demographics, past usage, etc. as is known in the art, and as mentioned above. For example, and without limiting the generality of the foregoing, either users who have never clipped a coupon for a product may be preferentially targeted, or, alternatively, those users who have accrued a consistent history of clipping and redeeming coupons for the product may be targeted.

In another embodiment, N can be modified according to the following scheme: Only X (N=X) coupons are provided by the provider of coupons. Based on an anticipated “clip rate per opportunity” a number of coupons greater than X are made available (i.e. N is increased over time). The term “clip rate per opportunity” is understood to mean that some method is utilized by the provider of the electronic publication 210 to monitor the clip rate each time an electronic publication 210 is provided to a group of user devices 120. If fewer coupons were clipped than anticipated, fewer electronic publications 210 will be distributed during the next distribution cycle to the next group of user devices 120 scheduled to receive the electronic publications 210. By way of a non-limiting example, if the observed clip rate for a given coupon is 10% of all coupons in all of the electronic publications 210 distributed on day 1 of a campaign, then when the next batch of electronic publications 210 are distributed to the next batch of user devices 120, N can be varied accordingly. This process can repeat iteratively. For example, and without limiting the generality of the foregoing:

During week one of a campaign with a budget of $100,000, 200,000 $1.00 dollar coupons are distributed in to receiving devices in an electronic publication sent to all registered users in the city of Monroe. At the end of week one, there were 500,000 coupons confirmed to the coupon distributing headend as being clipped. Thus, the observed clip rate is 50% (of the total budget).

The original plans of the campaign were to distribute the electronic publication to all registered users in the cities of Madison and Jackson. However, the total number of registered users in the cities of Madison and Jackson exceeds 100,000, (i.e. if half of these 100,000 coupons are clipped, then the full number of budgeted coupons will have been clipped). Thus, it may be necessary to either not distribute coupons in Jackson, or to increase the budget of the campaign.

More generally speaking, after the first opportunity, the system evaluates two numbers:
X′—the amount of coupons that were actually clipped; and
X′/X—the clip rate per opportunity.
   Based on these two numbers, X′ and X′/X that the system will decide how many coupons to present in the next opportunity. This system takes into account information such as how many people are seeing the coupon for the first time and how many are seeing a repeat impression—and calculates the anticipated “clip rate—per opportunity” for each of the groups as discussed above.

If the clip rate is much higher than expected, the next group to receive the coupons will either be very small or will be empty (unless the budget is changed). If the clip rate is much lower than expected, the coupon provider might significantly increase the size of the next group to receive the coupons or declare the campaign a failure and terminate it.

Decision about which users should receive the electronic publication with an offer to receive the coupons can be based on different criteria such as demographics, past usage, etc., as discussed above.

Decision about which users should get a second opportunity to clip coupons can be based on different criteria such as demographics, past usage, etc.

One example of using demographic criteria for coupon distribution would be a case where a given number T coupons are available for a specific product but of T, M (M<T) should be allocated for men and W (W<M, M+W=T) for women. An example for this could be a bar distributing coupons for entrance where the bar would like to enforce gender diversity among its visitors. Another example could be a fashion product (say a sports gear brand) where the advertisers would like visibility of this brand in different regions (to increase buying of this product by other people—without the coupons). In this case only a subset of T will be available in different regions. In both examples once M, W, etc. are reached in each demographic segment the coupon distribution for this segment will stop, but it will continue for other segments.

Coupon distribution may also be time based. Coupons can be offered to people according to a time which they are most likely to use the coupon—before they usually go shopping; when we estimate they've ran out of this product; etc.).

In this case I (number of coupons) can be scattered over the week, where each day will not receive necessarily a quota of I/7 coupons but will rather receive a proportion according to either known buying habits (for example if 30% of the population are buying their groceries on Thursdays, 30% of the coupons will be offered on say Wednesday evening). This is in case that the habits of the individual users are not known. Alternatively, in a case where coupons are distributed in an electronic magazine, user usage habits can be collected, and then subsequent coupons distribution will be based on real data coming from users—i.e. users will be offered coupons say a day before they normally shop. Still another example for recurring items is that coupons are distributed to users when it is estimated that the users have ran out of the product. For instance, if a user buys diapers every 2 weeks, diaper coupons will be distributed to him every 2 weeks. If ˜2 weeks is a common number for many users then X (number of coupons) should be distributed (evenly or not) over 14 days. Distributing all X coupons in a single day may result in a low redemption rate as most customers will still have enough diapers in stock.

In still another embodiment, N can be modified according to the following scheme: Each user click on a CLICK COUPON button in the electronic publication 210 is sent to the coupon distributing headend along with a time stamp, for instance, the time of a clock in a smart card or some other clock in the device. While it is preferable for the clock which provides the time stamp to be a secure clock, the nature of the device might preclude this. In such a case, a non-secure clock comprised in the device will, per-force, provide the time stamp.

Each request received by the coupon distributing headend is examined to determine which requests preceded which other requests. Only the first X requests (judged by the accompanying time stamp accompanying the request) are sent the virtual coupon. That is to say, if the total amount of clipped coupons exceeds X, then the coupon distributing headend will cease distributing coupons. If X has not yet been exceeded, then the coupon distributing headend will continue to distribute coupons until X is exceeded. Then the coupon distributing headend will cease. Should there be a conflict in that the number of pending requests for coupons (i.e. users who have tried to clip the coupons) a server 110 at the coupon distributing headend needs to determine which user's request has a priority to have its request filled over another user's request. The server 110 compares the time stamps comprised in the requests, and the request with the earlier time stamp will be granted first.

In such a case, X is compared to N from time to time. When X approaches N, N can be varied, up or down, as deemed proper.

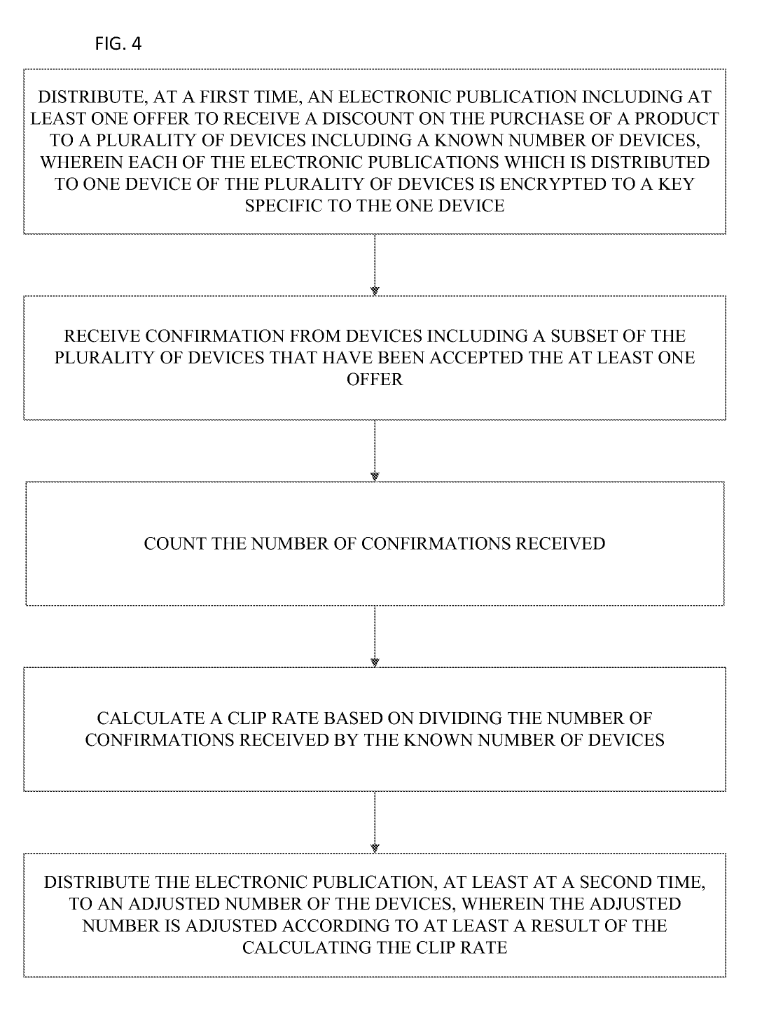

Reference is now made to FIG. 4, which is a flowchart diagram depicting a method for the embodiment of the system of FIG. 1. FIG. 4 is believed to be self-explanatory in light of the above discussion.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

1. A system comprising:
an electronic publisher implemented on one of a computer or processing device operative to publish an electronic publication comprising at least one offer to receive a discount on the purchase of a product;
an encryption engine which encrypts each copy of the electronic publication to a key specific to one device among a plurality of devices comprising a known number of individual devices;
distribution apparatus implemented on one of a computer or processing device which distributes, at least at a first time, the encrypted electronic publication to each individual device among the plurality of devices;
confirmation receiving apparatus implemented on one of a computer or processing device which receives confirmation from the individual devices that the at least one offer has been accepted on the one device; and
one of a computer or processing device comprising:
a counter which counts the number of confirmations received;
a calculator which calculates a clip rate based on dividing the number of confirmations received by the known number of individual devices; and
a processor which, based on a result of the calculation of the clip rate, adjusts the number of individual devices comprising a second plurality of devices, to which, at a second time, the electronic publication is to be distributed by the distribution apparatus.

2. The system of claim 1 wherein the confirmation received from one device among a plurality of devices is encrypted to the key specific to the one device.

3. The system of claim 1 wherein the coupon is redeemable once it is clipped on the one device.

4. The system of claim 1 wherein a coupon is redeemable within a window of opportunity.

5. The system of claim 1 wherein the one device is only occasionally connected to a network.

6. The system of claim 5 wherein the network comprises the Internet.

7. The system of claim 1 wherein the system further monitors coupon redemption rate.

8. The system of claim 7 wherein the processor, based on the coupon redemption rate further adjusts the number of individual devices comprising a second plurality of devices, to which, at a second time, the electronic publication is to be distributed by the distribution apparatus.

9. The system according to claim 1 and further comprising:
an upper threshold, denoted N, N being a maximum number of redeemable tokens available for distribution by the distribution apparatus; and
the confirmation from received the one device comprising, at least:
a time-stamp; and
device identification information.

10. The system of claim 9 wherein the time-stamp comprises a time stamp from a secure clock.

11. The system of claim 10 wherein the secure clock is comprised in a secure hardware element comprised in the device.

12. A method comprising:
distributing, at a first time, an electronic publication comprising at least one offer to receive a discount on the purchase of a product to a plurality of devices comprising a known number of devices, wherein each of the electronic publications which is distributed to one device of the plurality of devices is encrypted to a key specific to the one device;
receiving confirmation from devices comprising a subset of the plurality of devices that have been accepted the at least one offer;
counting the number of confirmations received;
calculating a clip rate based on dividing the number of confirmations received by the known number of devices; and
distributing the electronic publication, at least at a second time, to an adjusted number of the devices, wherein the adjusted number is adjusted according to at least a result of the calculating the clip rate.

13. Apparatus comprising:
electronic publishing means for publishing an electronic publication comprising at least one offer to receive a discount on the purchase of a product;
encryption means for encrypting each copy of the electronic publication to a key specific to one device among a plurality of devices comprising a known number of individual devices;
distribution means for distributing, at least at a first time, the encrypted electronic publication to each individual device among the plurality of devices;
confirmation receiving means for receiving confirmation from the individual devices that the at least one offer has been accepted on the one device; and
one of a computer or processing device comprising:
counting means for counting the number of confirmations received;
calculating means for calculating a clip rate based on dividing the number of confirmations received by the known number of individual devices; and
a processor which, based on a result of the calculation of the clip rate, adjusts the number of individual devices comprising a second plurality of devices, to which, at a second time, the electronic publication is to be distributed by the distribution apparatus.
